(19) United States
(12) Patent Application Publication
(10) Pub. No.: US 2006/0263664 A1
(43) Pub. Date: Nov. 23, 2006

(54) Reactant management of a wet end cell in a fuel cell stack

(76) Inventors: Sitima R. Fowler, Fairport, NY (US); Seth Valentine, Oklahoma City, OK (US); Charles MacKintosh, Victor, NY (US); Steven L. Piedmont, Macedon, NY (US)

Correspondence Address: CARY W. BROOKS;General Motors Corporation, Legal Staff, Mail Code 482-C23-B21, P.O. Box 300, Detroit, MI, 48265-3000, US

(21) Appl. No.: 11/132,984

(22) Filed: May 19, 2005

(51) Int. Cl. H01M 8/24; H01M 8/02

(52) U.S. Cl. 429/34; 429/38; 429/13

(57) ABSTRACT

In at least certain embodiments, the present invention relates to a fuel cell stack comprising a fuel cell assembly having opposite first and second ends, a wet end fuel cell adjacent the first end, a dry end fuel cell adjacent the second end, and a plurality of repeating fuel cells disposed between the wet end and dry end fuel cells. In at least certain embodiments, the wet end fuel cell comprises a unipolar plate and the repeating fuel cells each comprise one-half of each adjacent bipolar plate. In at least certain embodiments, the unipolar plate has a first oxidant rate, and at least one of the bipolar plates has a second oxidant rate, with the first oxidant rate being less than the second oxidant rate.

### BACKGROUND OF THE INVENTION

1. Field of the Invention

The present invention relates generally to fuel cell stacks and more particularly to a fuel cell stack having a unipolar plate with a modified oxidant rate relative to at least a majority of the bipolar plates.

2. Background Art

Fuel cells have been used as a power source in many applications. For example, fuel cells have been proposed for use in electrical vehicular power plants to replace internal combustion engines. In proton exchange membrane (PEM) type fuel cells, hydrogen is supplied to the anode of the fuel cell and oxygen is supplied as the oxidant to the cathode. The oxygen can be either a pure form (O₂) or air (a mixture of O₂ and N₂). PEM fuel cells include a membrane electrode assembly (MEA) comprising a thin, proton transmissive, non-electrically conductive, gas impermeable, solid polymer electrolyte membrane having the anode catalyst on one face and the cathode catalyst on the opposite face. The MEA is sandwiched between a pair of non-porous, electrically conductive elements or plates which (1) serve as current collectors for the anode and cathode, and (2) contain appropriate channels and/or openings formed therein for distributing the fuel cell's gaseous reactants over the surfaces of the respective anode and cathode catalysts.

The term “fuel cell” is typically used to refer to either a single cell or a plurality of cells (stack) depending on the context. A plurality of individual cells are typically bundled together to form a fuel cell stack and are commonly arranged in electrical series. Each cell within the stack includes the membrane electrode assembly (MEA) described earlier, and each such MEA provides its increment of voltage. By way of example, some typical arrangements for multiple cells in a stack are shown and described in U.S. Pat. No. 5,663,113.

The electrically conductive end plates sandwiching the MEAs typically contain an array of grooves in the faces thereof that define a reactant flow field for distributing the fuel cell's gaseous reactants (i.e., hydrogen and oxygen in the form of air) over the surfaces of the respective cathode and anode. These reactant flow fields generally include a plurality of lands that define a plurality of flow channels therebetween through which the gaseous reactants flow from a supply header at one end of the flow channels to an exhaust header at the opposite end of the flow channels. These end plates are commonly referred to as unipolar plates.

In a fuel cell stack, a plurality of cells are stacked together in electrical series while being separated by a gas impermeable, electrically conductive bipolar plate. In some instances, the bipolar plate is an assembly formed by securing a pair of thin metal sheets having reactant flow fields formed on their external, face surfaces. Typically, an internal coolant flow field is provided between the metal plates of the bipolar plate assembly. Various examples of a bipolar plate assembly of the type used in PEM fuel cells are shown and described in commonly-owned U.S. Pat. No. 5,766,624.

Fuel cell stacks produce electrical energy efficiently and reliably. However, as they produce electrical energy, losses in the electrochemical reactions and electrical resistance in the components that make up the stack produce waste thermal energy (heat) that must be removed for the stack to maintain a constant optimal temperature. Typically, the cooling system associated with a fuel cell stack includes a circulation pump for circulating a single-phase liquid coolant through the fuel cell stack to a heat exchanger where the waste thermal energy (i.e., heat) is transferred to the environment. The two most common coolants used are de-ionized water and a mixture of ethylene glycol and de-ionized water.

The capability of the wet end cell to reliably produce voltage as high as normal repeating cells has long been an issue affecting the reliability of the fuel cell stack. When the wet end cell voltage falls below a critical threshold the entire fuel cell stack may become inoperative. It would be desirable to provide a wet end cell that operates more like a normal repeating cell to thereby increase the life of a fuel cell stack.

### SUMMARY OF THE INVENTION

In at least one embodiment, the present invention comprises a fuel cell assembly having opposite first and second ends, a wet end fuel cell adjacent the first end, a dry end fuel cell adjacent the second end, and a plurality of repeating fuel cells disposed between the wet end and dry end fuel cells. In accordance with this embodiment, the wet end fuel cell comprises a unipolar plate and the repeating fuel cells each comprise one-half of each adjacent bipolar plate. Further in accordance with this embodiment, the unipolar plate has a first oxidant rate and at least one of the bipolar second plates has a second oxidant rate, with the first oxidant rate being less than the second oxidant rate.

The present invention also comprises a method of providing reactant to a wet end cell in a fuel cell stack. In at least one embodiment, the method comprises operating a fuel cell system comprising the fuel cell stack. In accordance with this embodiment, the fuel cell stack comprises a wet end fuel cell comprising a unipolar plate, a dry end fuel cell, and a plurality of repeating fuel cells disposed between the wet end and dry end fuel cells, with each of the repeating fuel cells comprising one-half of each adjacent bipolar plate. Further in accordance with this embodiment, oxidant is provided to the wet end unipolar plate having a first oxidant rate, and oxidant is provided to at least one of the bipolar plates having a second oxidant rate with the second oxidant rate being greater than the first oxidant rate.

In still yet at least another embodiment, the present invention comprises a fuel cell assembly having opposite first and second ends, a wet end fuel cell adjacent the first end, a dry end fuel cell adjacent the second end, and a plurality of repeating fuel cells disposed between the wet end and dry end fuel cells. In accordance with this embodiment, the wet end fuel cell comprises a unipolar plate having a first oxidant flow rate and the repeating fuel cells each comprise one-half of each adjacent bipolar plate with at least one of the bipolar plates having a second oxidant flow rate with the first oxidant flow rate being less than the second oxidant flow rate. Further in accordance with this embodiment, the unipolar plate has a first number of oxidant inlet openings and a second number of oxidant outlet openings, with the second number being greater than the first number such that the first oxidant flow rate is less than 93% of the second oxidant flow rate.

Further areas of applicability of the present invention will become apparent from the detailed description provided herein. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings where like structure is indicated with like reference numerals and in which:

FIG. 1 is an exploded isomeric view of a PEM fuel cell stack;

FIG. 2 is a schematic illustration of a fuel cell stack and oxidant system;

FIG. 3 is an exemplary unipolar plate illustrating an exemplary embodiment of the present invention;

FIG. 4 is a view similar to FIG. 3 illustrating another exemplary embodiment of the present invention;

FIG. 5 is a view similar to FIG. 2 illustrating another exemplary embodiment of the patent invention;

FIG. 6 is a polarization graph portraying cell voltage achieved by a fuel cell stack of the present invention in comparison to a fuel stack not embodying the present invention; and

FIG. 7 is a polarization graph portraying HFR (cell resistance) achieved by a fuel cell stack of the present invention in comparison to a fuel cell stack not embodying the present invention.

### DETAILED DESCRIPTION OF THE PREFERRED EMBODIMENTS

The following description of the preferred embodiments is merely exemplary in nature and is in no way intended to limit the invention, its application, or uses. Reference will now be made in detail to presently preferred compositions, embodiments and methods of the present invention, which constitute the best modes of practicing the invention presently known to the inventors. The figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative bases for the claims and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of”, and ratio values are by weight; the term “polymer” includes “oligomer”, “copolymer”, “terpolymer”, and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and to normal grammatical variations of the initially defined abbreviation; and, unless expressly stated to the contrary, measurement of a property is determined by the same technique as previously or later referenced for the same property.

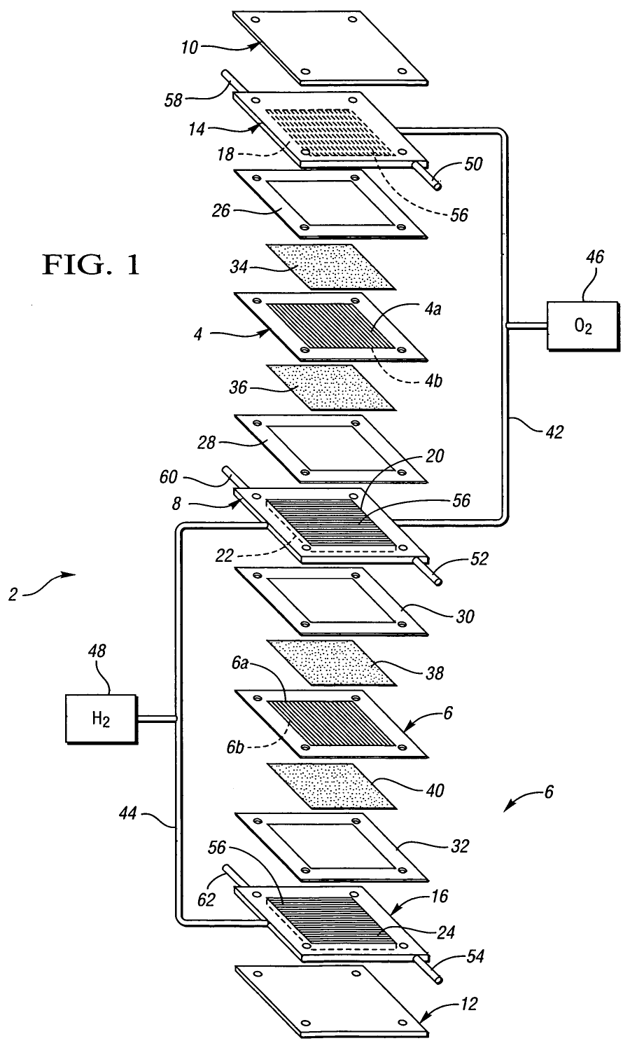

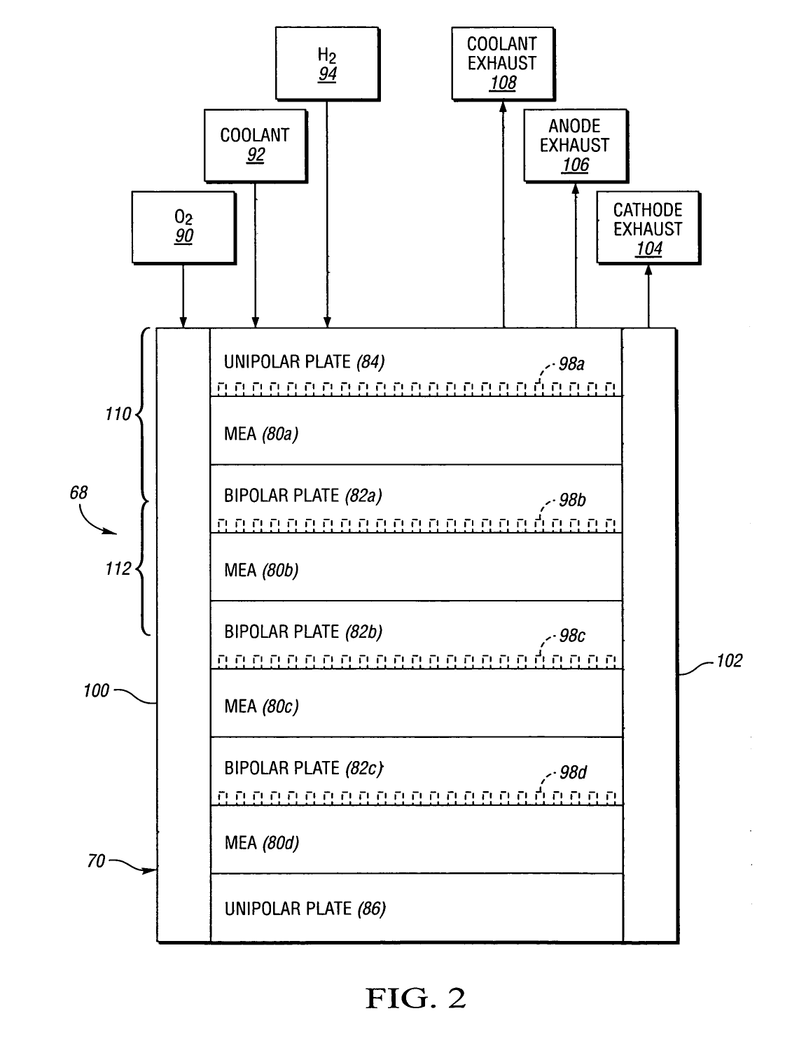

Before further describing the invention, it is useful to understand an exemplary fuel cell system within which the invention operates. FIG. 1 has been provided for this purpose. For simplicity, only a two-cell stack (i.e., one bipolar plate) is shown in FIG. 1, it being understood that a typical stack, such as the one schematically illustrated in FIG. 2, will have many more cells and bipolar plates.

FIG. 1 schematically depicts a PEM fuel cell stack 2 having a pair of membrane-electrode assemblies (MEAs) 4 and 6 separated from each other by a non-porous, electrically-conductive, liquid-cooled bipolar plate assembly 8. Each MEA 4 and 6 has a corresponding cathode face 4a, 6a and an anode face 4b and 6b. MEAs 4 and 6 and bipolar plate assembly 8 are stacked together between non-porous, electrically-conductive, liquid-cooled monopolar end plate assembly 14 and 16. Steel clamping plates 10 and 12 are provided for enclosing the exemplary fuel cell stack 2. Connectors (not shown) are attached to clamping plates 10 and 12 to provide positive and negative terminals for the fuel cell stack. Bipolar plate assembly 8 and end plate assemblies 14 and 16 include corresponding flow fields 20, 22, 18 and 24, each having a plurality of flow channels formed in the faces thereof for distributing fuel and oxidant gases (i.e., H₂ and O₂) to the reactive faces of MEAs 4 and 6. Nonconductive gaskets or seals 26, 28, 30, and 32 provide a seal and electrical insulation between the several plates of the fuel cell stack.

With continued reference to FIG. 1, porous, gas permeable, electrically conductive sheets 34, 36, 38 and 40 are shown to be pressed up against the electrode faces of MEAs 4 and 6 and serve as primary current collectors for the electrodes. Primary current collectors 34, 36, 38 and 40 also provide mechanical supports for MEAs 4 and 6, especially at locations where the MEAs are otherwise unsupported in the flow fields.

End plates 14 and 16 press up against primary current collector 34 on cathode face 4a of MEA 4 and primary current collector 40 on anode face 6b of MEA 6 while bipolar plate assembly 8 presses up against primary current collector 36 on anode face 4b of MEA 4 and against primary current collector 38 on cathode face 6a of MEA 6. An oxidant gas, such as oxygen or air, is supplied to the cathode side of the fuel cell stack from a storage tank 46 via appropriate supply plumbing 42. Similarly, a fuel, such as hydrogen, is supplied to the anode side of the fuel cell from a storage tank 48 via appropriate supply plumbing 44. In a preferred embodiment, oxygen tank 46 may be eliminated, such that ambient air is supplied to the cathode side from the environment. Likewise, hydrogen tank 48 may be eliminated and hydrogen supplied to the anode side from a reformer which catalytically generates hydrogen from methanol or a liquid hydrocarbon (e.g., gasoline). While not shown, exhaust plumbing for both the H₂ and O₂/air sides of MEAs 4 and 6 is also provided for removing H₂-depleted anode reactant flow field and O₂-depleted cathode gas from the cathode reactant flow field.

Coolant supply plumbing 50, 52, and 54 is provided for supplying a liquid coolant from an inlet header (not shown) of the fuel cell stack to the coolant flow fields of bipolar plate assembly 8 and end plates 14 and 16. The coolant flow fields of the bipolar plate assembly 8 and end plates 14 and 16 include long narrow channels 56 defining coolant passages within the plates 8, 14, and 16. As shown in FIG. 1, coolant exhaust plumbing 58, 60, and 62 is provided for exhausting the heated coolant discharged from bipolar plate assembly 8 and end plates 14 and 16 of the fuel cell stack 2.

FIG. 2 is a schematic diagram of a fuel cell assembly 68. As shown in FIG. 2, the fuel cell assembly 68 includes a schematically illustrated fuel cell stack 70, such as the one shown in FIG. 1. Fuel cell stack 70 is illustrated to have only four MEAs 80 and three bipolar plates 82a-c, it being understood that a typical stack will have many more MEA's and bipolar plates. Fuel cell stack 70 contains end plates 84 and 86. The number of MEAs that are stacked adjacent to one another to form the fuel stack 70 can vary. The number of MEAs that are utilized to form the fuel cell stack 70 is dependent upon the needs of the fuel cell stack. That is, when a larger or more powerful fuel cell stack 70 is desired, the number of MEAs in the fuel cell stack will be increased.

Oxidant 90, coolant 92 and hydrogen 94 are supplied to the fuel cell stack 70 via appropriate plumbing. As shown in the schematic illustration of FIG. 2, each of the bipolar plates 82a-c, and the end plate 84 has an oxidant flow field 98a-d, respectively, adjacent an MEA. All of the oxidant flow fields 98a-d are connected at one side of the stack 70 to a distributor manifold 100 which receives oxidant from oxidant source 90 for feeding oxidant to the cathodes of the MEA's 80a-d. The oxidant flow fields 98a-d are all connected at the other side of the stack 70 to a collection manifold 102 which directs cathode exhaust gases flowing through the plates out of fuel cell stack to cathode outlet 104. The fuel cell stack 70 construction similarly defines, in a manner known per say, additional manifolds (not shown) for the feeding of hydrogen or a synthesized hydrogen-rich gas from source 94 to the anodes of the MEA's 80a-d and for feeding coolant from source 92 through the plates 82a-c, 84 and 86. The fuel stack 70 construction similarly defines, in a manner known per say, additional manifolds (not shown) for conducting the anode exhausts gases and coolant exhaust away from the fuel cell stack 70 to outputs 106 and 108, respectively. The end of the fuel cell stack 70 having the inlets for 90, 92 and 94 and outlets 104, 106, and 108 is also referred to as the “wet end.” The opposite end of the fuel cell stack 70 is also referred to as the “dry end.”

A fuel cell is formed when an MEA is interposed between adjacent plates. For instance, unipolar plate 84, MEA 80a, and roughly half of bipolar plate 82a form a fuel cell 110, while the other half of bipolar plate 82a, MEA 80b, and roughly half of bipolar plate 82b form another fuel cell 112. The cell 110 closest to the wet end is commonly referred to as the “wet end cell” or “cell n.” The cell n 110 is shown to be the last cell in the cell stack 70. Fuel cell 112 is an exemplary non-end cell or normal repeating cell. The cell opposite cell n 110 and adjacent the dry end is commonly referred to as the “dry end cell.”

The present invention helps to ensure that the wet end cell performance is relatively consistent with the repeating cells performance and that the wet end cell's MEA is adequately humidified thereby increasing the wet end cell's capability to reliably produce voltage as high as the normal repeating cells. The present invention accomplishes this by modifying the oxidant rate of the unipolar plate 84 relative to the bipolar plates 82a-c and dry end unipolar plate 86.

In conventional systems, the flow rate of oxidant directed to the wet end unipolar plate, such as 84, is intended to be substantially the same as the flow rate of oxidant directed to bipolar plates, such as 82a-c, and the dry end unipolar plate, such as 86. As such, the humidification of the wet end MEA, such as 80a, is intended to be substantially the same as the humidification of the other MEA's such as 80b-d. However, due to several factors pertinent to the design of a typical fuel cell stack, such as 70, applicants believe that the relative humidity (RH) of the oxidant flowing adjacent the wet end cell MEA, such as 80a, is less than the RH of the oxidant flowing adjacent the other MEA's, such as 80b-d. Thus, applicants believe that the humidification of the wet end MEA is less relative to the other MEA's

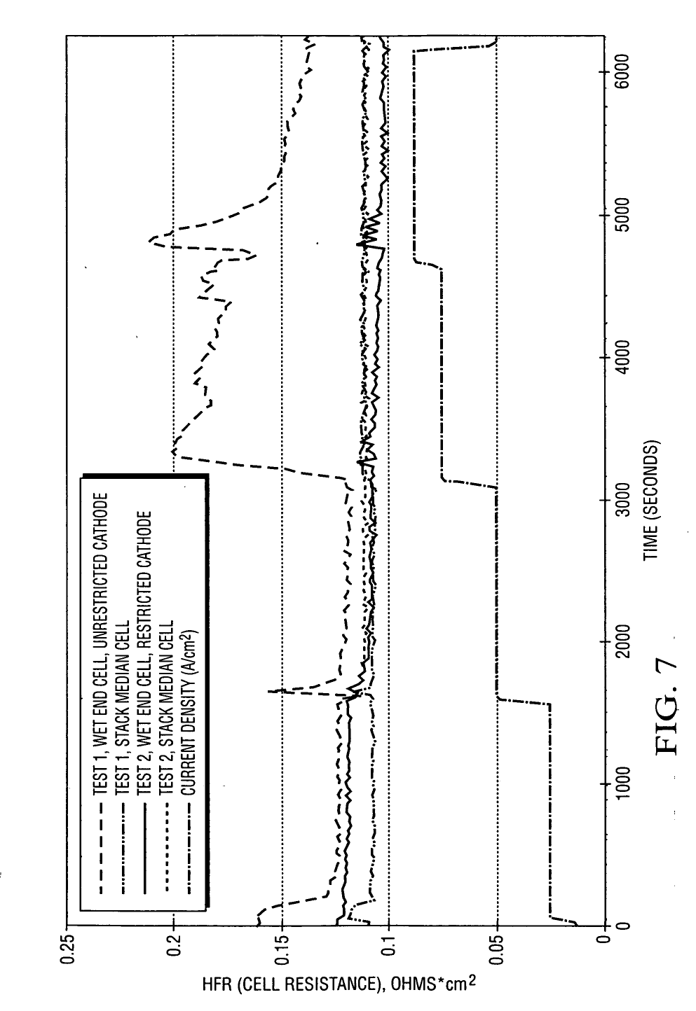

Such design factors are believed to include overcooling of the wet end unipolar plate and/or a higher oxidant flow rate to the wet end unipolar plate relative to the other plates. Overcooling can cause moisture from the air stream to be drawn out, thereby leaving less moisture to humidify the MEA, such as 80a. A higher oxidant flow rate to the unipolar plate, such as 84, can be problematic in that it would tend to translate to a lower RH relative to a cell with a lower oxidant flow rate. The observed differences in HFR tests for wet end cells relative to the stack's median cell voltage, as can be seen in FIG. 7, tend to support applicant's beliefs.

Since the RH of oxidant flowing adjacent to the wet end MEA, such as 80a, is believed to be less than the RH of the oxidant flowing adjacent the other MEA's, such as 80b-d, applicants believe that the wet end cell MEA, such as 80a, is “dry.” Applicants believe that this dryness of the wet end cell MEA decreases the voltage produced in the wet end cell and thus decreases performance and lifetime of the fuel cell stack.

Since RH is inversely related to oxidant amount, in accordance with the present invention, applicants have provided an oxidant system in which a first amount (or flow rate) of oxidant is provided to the oxidant flow field 98a of the unipolar plate 84 and a second amount of oxidant is substantially provided to each of the oxidant flow fields 98b-d of the bipolar plates 82a-c, respectively, in the normal repeating cells and dry end unipolar plate 86. The first amount is at least substantially less than the second amount. In at least one embodiment, the first amount is no more than 95% (based on mass flow rate) of the second amount, while in another embodiment the first amount is between 60%-93% of the second amount, while yet in another embodiment is between 70%-90% of the second amount. For instance, if the oxidant flow rate in bipolar plate 82a is about 13.0 slpm (standard liter/minute), the oxidant flow rate in the unipolar plate 84 is, in at least one embodiment, no more than 12.35 slpm, in at least another embodiment between 7.8-12.0 slpm, and in yet another embodiment between 9-11.7 slpm.

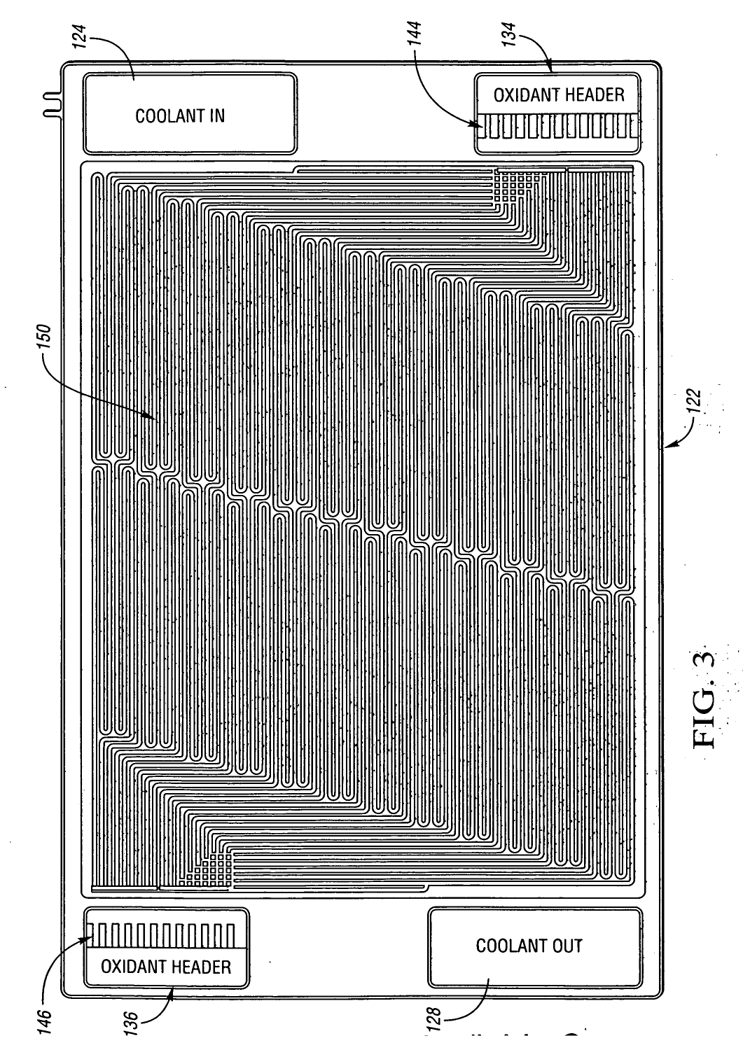

The manner in which the reduced (i.e., first) amount of oxidant directed to the unipolar plate 84 is achieved is not necessarily important. The amount of oxidant introduced into the wet end unipolar plate 84 can be reduced relative to the amount of oxidant introduced into the bipolar plates 82a-c and dry end unipolar plate 86 in a variety of manners. To help illustrate at least one of these manners, a schematic representation of the oxidant flow field of a unipolar plate 122 is provided in FIG. 3.

The unipolar plate 122 illustrated in FIG. 3 has a coolant inlet 124 and a coolant outlet 128, both schematically illustrated, connected with appropriate inlet and outlet manifolds. The unipolar plate 122 also includes an appropriate coolant flow field (not shown) for delivering the coolant to the plate in a manner that is know in the art. The unipolar plate 122 also includes an oxidant inlet 134 and an oxidant outlet 136, connected with appropriate inlet and outlet manifolds. In the schematic representation illustrated in FIG. 3, the oxidant inlet 134 has twenty-four inlet openings 144 and the oxidant outlet 136 has twenty-four corresponding outlet openings 146. In the plate 122 illustrated in FIG. 3, the inlet openings 144 and outlet openings 146 are each provided in two rows (only one of which is shown) of twelve openings. It is contemplated that this configuration can vary as desired. While twenty-four inlet and twenty-four outlet openings 144 and 146 are contemplated for unipolar plate 122 it should be understood that more or less openings 144 and/or 146 could be provided as desired.

Oxidant flow field, generally designated at 150, comprises channels extending between the inlet and outlet openings 144 and 146, respectively. One manner to reduce the amount of oxidant introduced into the unipolar plate 122 is to provide plate 122 with at least some of the inlet and/or outlet openings 144 and/or 146 and/or the channels 150 that are smaller in size or area (i.e., diameter) than those in the bipolar plates 82a-c and dry end unipolar plate 86, used in the same stack. For illustration purposes only, the inlet openings 144 in plate 122 are schematically illustrated as being smaller in size than inlet openings 144.

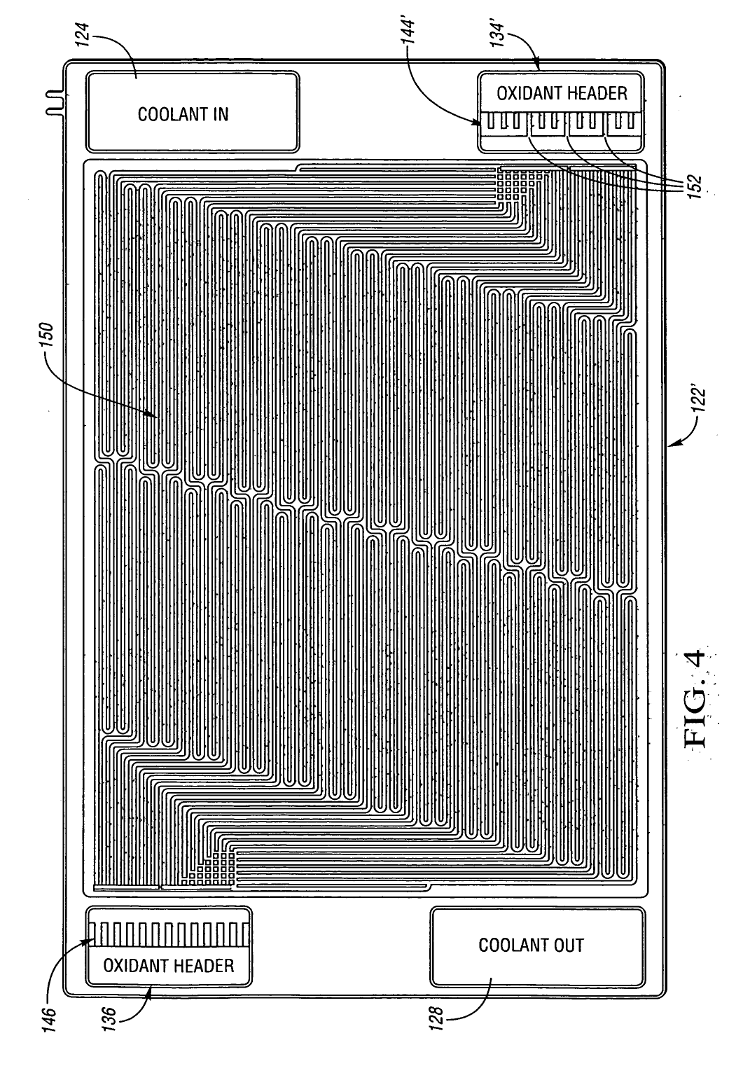

To help illustrate another manner in which the oxidant introduced into unipolar plate 84 can be reduced relative to the amount of oxidant introduced into the bipolar plates 82a-c and dry end unipolar plate 86, schematic representation of a unipolar plate 122′ is provided in FIG. 4. Referring to FIG. 4, like the plate 122 illustrated in FIG. 3, the unipolar plate 122′ has twenty-four outlet openings 146. The outlet openings 146 can be substantially the same in size or area as the outlet openings in the bipolar plates 82a-c and unipolar plate 86 used in the same stack. To achieve the desired reduction in oxidant flow in unipolar plate 122′ some of the inlet openings 144′ are closed, or essentially closed.

In the embodiments where a portion of the inlet openings 144′ are closed, the closing of the openings can be accomplished by designing the unipolar plate 122′ to have fewer inlet openings 144′. In another embodiment, the inlet openings 144′ could be blocked with a suitable material such as epoxy resin.

In the exemplary embodiment illustrated in FIG. 4, eighteen of the twenty-four outlet openings 146′ are closed, leaving (only three of which are shown) openings 152 opened. In at least one embodiment, this has been found effective to yield an oxidant flow rate that is substantially less in unipolar plate 122′ than in bipolar plates 82a-c and unipolar plate 86. Although the number of inlet openings 144′ that will be closed will depend largely upon the design requirements associated with the particular application in which the unipolar plate 122′ is to be utilized, it is noted that percent closure of 10-95% of the inlet openings 144′, and more particularly 60-80%, are likely to find utility. While the embodiment illustrated in FIG. 4 shows only inlet openings 144′ being closed while leaving all of the outlet openings 146 open, it is contemplated that a unipolar plate 122′ could be provided which has only a portion of the outlet openings 146 closed while having all of the inlet openings 144′ open or having portions of both the inlet and outlet openings 144′ and 146 closed in any desired configuration.

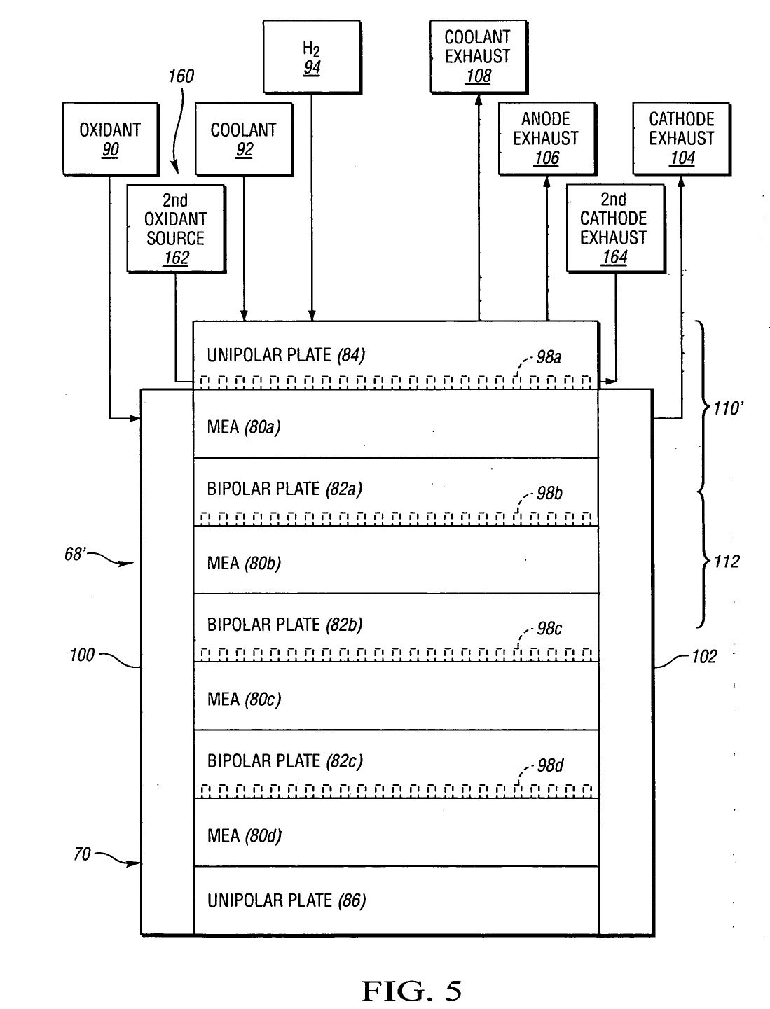

In yet another embodiment, as best illustrated in FIG. 5, instead of restricting the amount of flow to the unipolar plate 84 by modifying the unipolar plate, a separate oxidant circuit 160 can be provided to provide oxidant from a second oxidant source 162 just for the unipolar plate 84. The second oxidant source 162 delivers oxidant directly to oxidant flow field 98a from second oxidant source 162 and includes an oxidant exhaust 164, also associated with oxidant flow field 98a. In this embodiment, the oxidant from second oxidant source 162 could be provided with a different oxidant property than the oxidant provided to the bipolar plates 82a-c and plate 86 from oxidant source 90. The oxidant from second oxidant source 162 could be more or less oxidative and/or humid than the oxidant provided to the bipolar plates from first oxidant source 90. In this alternative embodiment, the oxidant flow from second oxidant source 162 could be adjusted to provide a lower oxidant flow rate to the unipolar plate 84 relative to plates 82a-c and 86.

The present invention will be further explained by way of examples. It is to be appreciated that the present invention is not limited by the examples.

### EXAMPLES

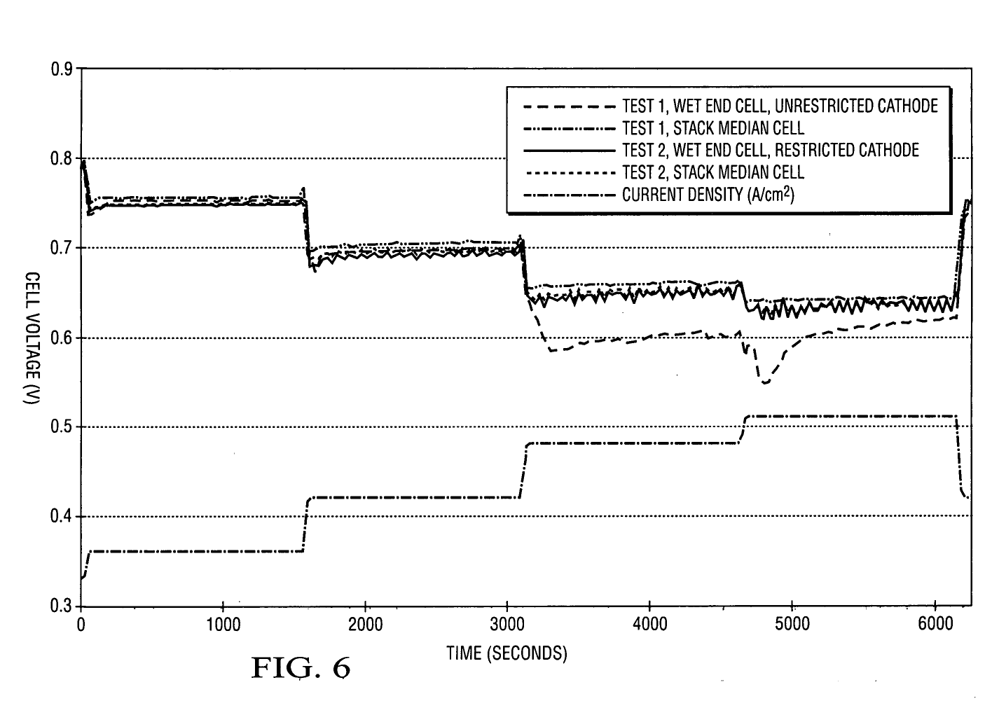

In test 1, a 15 cell test stack at a current density of 0.6 A/cm² is operated with an oxidant (air) flow rate of 13.0 slpm (standard liter/minute) per cell. The wet cell voltage and the stack median cell voltage over time of test 1 are plotted in FIG. 6. Test 2: is similar to test 1 except that the wet end cell has a restricted cathode inlet such that the oxidant flow rate at a current density of 0.6 A/cm² through the wet end cell is 11.5 slpm, while the oxidant flow rate for the other 14 cells is 13.0 slpm per cell. The wet end cell voltage and stack median cell voltage over time of test 2 are plotted in FIG. 6. As can be seen in FIG. 6, the difference in wet end cell voltage and the stack median cell voltage in test 1 is significant at various points along the graph. The difference in wet end cell voltage and the stack median cell voltage for test 2 are much smaller along every point of the graph.

The wet end cell HFR (high frequency cell resistance) and the stack median cell HFR over time of test 1 are plotted in FIG. 7. The wet end cell HFR and the stack median cell HRF over time of test 2 are plotted in FIG. 7. As can be seen in FIG. 7, the difference in wet end cell HFR and the stack median cell HFR in test 1 is significant at various points along the graph. The difference in wet end cell HFR and the stack median cell HFR for test 2 are much smaller along every point of the graph.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A fuel cell stack comprising:
a fuel cell assembly having opposite first and second ends, a wet end fuel cell adjacent the first end, a dry end fuel cell adjacent the second end, and a plurality of repeating fuel cells disposed between the wet end and dry end fuel cells;
the wet end fuel cell comprising a unipolar plate;
the repeating fuel cells each comprising one-half of each adjacent bipolar plate; and
the unipolar plate having a first oxidant rate, and at least one of the bipolar plates having a second oxidant rate, the first oxidant rate being less than the second oxidant rate.

2. The fuel cell stack of claim 1 wherein the unipolar plate has a first oxidant flow rate and the at least one bipolar plate has a second oxidant flow rate, the first oxidant flow rate being less than the second oxidant flow rate.

3. The fuel cell stack of claim 2 wherein the unipolar plate has a first number of oxidant outlet openings and a second number of oxidant inlet openings, the first number being greater than the second number.

4. The fuel cell stack of claim 2 wherein the unipolar plate has an oxidant inlet area and an oxidant outlet area, the oxidant outlet area being greater than the oxidant inlet area.

5. The fuel cell stack of claim 4 wherein the unipolar plate has a first amount of total combined oxidant inlet openings and oxidant outlet opening, and the at least one bipolar plate has a second amount of total combined oxidant inlet openings and oxidant outlet openings, with the first amount being greater than the second amount.

6. The fuel cell stack of claim 5 wherein the unipolar plate has a first number of oxidant outlet openings and a second number of oxidant inlet openings, the first number being greater than the second number.

7. The fuel cell stack of claim 4 wherein the unipolar plate has a substantial number of oxidant inlet openings having a diameter that is smaller than the diameter of a substantial number of oxidant outlet openings of the unipolar plate such that the total area of the oxidant inlet openings is less than the total area of the oxidant outlet openings.

8. The fuel cell stack of claim 1 further comprising a first oxidant system for supplying oxidant to the bipolar plates and a second oxidant system, separate from the first oxidant system, for supplying oxidant to the unipolar plate.

9. The fuel cell stack of claim 8 wherein the first oxidant system provides a first oxidant rate to at least one of the bipolar plates and the second oxidant system provides a second oxidant rate to the unipolar plate, with the second oxidant rate being less than the first oxidant rate.

10. The fuel cell stack of claim 4 wherein the first flow rate is less than 95% of the second flow rate.

11. The fuel cell stack of claim 10 wherein the first flow rate is 60 to 92% of the second flow rate.

12. A method of providing reactant to a wet end cell in a fuel cell stack, the method comprising operating a fuel cell system comprising the fuel cell stack, the fuel cell stack comprising a wet end fuel cell comprising a unipolar plate, a dry end fuel cell, and a plurality of repeating fuel cells disposed between the wet end and dry end fuel cells, each of the repeating fuel cells comprising one-half of each adjacent bipolar plate;
providing oxidant to the wet end unipolar plate having a first oxidant rate; and
providing oxidant to at least one of the bipolar plates having a second oxidant rate, the second oxidant rate being greater than the first oxidant rate.

13. The method of claim 12 wherein the unipolar plate has an oxidant inlet area and an oxidant outlet area, the oxidant outlet area being greater than the oxidant inlet area.

14. The method of claim 12 wherein the unipolar plate has a first oxidant flow rate and the at least one bipolar plate has a second oxidant flow rate, the first oxidant flow rate being less than the second oxidant flow rate.

15. The method of claim 12 wherein the unipolar plate has a first number of oxidant outlet openings and a second number of oxidant inlet openings, the first number being greater than the second number.

16. The method of claim 14 wherein the unipolar plate has a substantial number of oxidant outlet openings having a diameter that is greater than the diameter of a substantial number of oxidant inlet openings of the unipolar plate such that the total area of the oxidant output openings is greater than the total area of the oxidant inlet openings.

17. The method of claim 14 wherein the first flow rate is less than 95% of the second flow rate.

18. The method of claim 17 wherein the first flow rate is 60 to 92% of the second flow rate.

19. The method of claim 12 further comprising a first oxidant system for supplying oxidant to the bipolar plates and a second oxidant system, separate from the first oxidant system, for supplying oxidant to the unipolar plate, wherein the first oxidant system provides a first oxidant rate to at least one of the bipolar plates and the second oxidant system provides a second oxidant rate to the unipolar plate, with the second oxidant rate being less than the first oxidant rate.

20. A fuel cell stack comprising:
a fuel cell assembly having opposite first and second ends, a wet end fuel cell adjacent the first end, a dry end fuel cell adjacent the second end, and a plurality of repeating fuel cells disposed between the wet end and dry end fuel cells;
the wet end fuel cell comprising a unipolar plate having a first oxidant flow rate;
the repeating fuel cells each comprising one-half of each adjacent bipolar plate with at least one of the bipolar plates having a second oxidant flow rate, the first oxidant flow rate being less then the second oxidant flow rate; and
the unipolar plate having a first number of oxidant inlet openings and a second number of oxidant outlet openings, with the second number being greater than the first number such that the first oxidant flow rate is less than 93% of the second oxidant flow rate.
